(19) United States
(12) Patent Application Publication
(10) Pub. No.: US 2020/0017976 A1
(43) Pub. Date: Jan. 16, 2020

(54) METHOD OF MAKING AN ENAMELED SANITARY FIXTURE

(71) Applicants: Volker GERHARD, Hamm (DE); Raphael DEINERT, Herzebrock-Clarholz (DE)

(72) Inventors: Volker GERHARD, Hamm (DE); Raphael DEINERT, Herzebrock-Clarholz (DE)

(21) Appl. No.: 16/431,781

(22) Filed: Jun. 5, 2019

(30) Foreign Application Priority Data
Jul. 13, 2018 (DE) 102018117037.8

(51) Int. Cl. C23D 5/00; C23D 5/04; C03C 8/22; C03C 8/14

(52) U.S. Cl. CPC C23D 5/005; C03C 8/14; C03C 8/22; C23D 5/04

(57) ABSTRACT

A method for making an enameled sanitary product has a first step of applying a coating compound formed from at least one ground-enamel frit to a metallic base body. The compound contains a thermally unstable additive that decomposes when heated. Then the base body coated with the compound is fired such that the additive thermally decomposes and produces gas inclusions and craters that produce bubbles in and craters on the fired coating compound that are fixed by cooling.

### FIELD OF THE INVENTION

The present invention relates to the manufacture of a sanitary fixture. More particularly this invention concerns to an enameled bathtub, sink, tile, or the like.

### BACKGROUND OF THE INVENTION

An enameled sanitary product, particularly a bathtub, a shower base, a shower surface, or a floor tile is made by applying a coating compound formed from a ground-enamel frit to a metallic base body and then firing the coated base body. This is a conventional enameling process for forming an enameled sanitary product or fitting.

A blank for forming such a metallic sanitary product comprises a metallic base body and a coating on the base body made from a ground-enamel frit. The blank is an intermediate product of the previously described process prior to the firing process.

An end product, namely an enameled sanitary product, particularly in the form of a bathtub, shower base, shower surface, or a floor panel, typically comprises a metallic base body and with a surface enamel layer on the metallic base body and forms a wear surface thereof.

A person skilled in the art is familiar with the production of enamel and enameled products. Reference is made in this respect to the “Roempp Chemie Lexikon” [“Roempp's Chemistry Lexicon”], vol. 2, 9th edition, 1990, pp. 1147 et seq. and to “Ullmanns Encyklopadie der technischen Chemie” [“Ullmann's Encyclopedia of Industrial Chemistry”], volume 10, 4th edition, 1975, p. 436-447.

Quartz, feldspar, soda, calcium carbonate, borax, sodium nitrate, and fluorspar and aggregates are used as raw materials for enamel production, depending on the intended use. The raw materials are mixed and melted at about 1200° C. and solidified, the frit being produced in the form of granules or flakes, it being possible in the context of the invention for the term “enamel frit” to also refer to a mixture of different frits, a mixture of at least two frits being preferred.

It is known to differentiate enamels according to their functions. During enameling, for example, a multilayer structure with a base enamel and a top enamel is often provided, the base enamel producing an intensive adhesion between the metallic support and the top enamel being optimized in terms of its mechanical properties, decorative properties, and corrosion resistance.

In the field of enameled sanitary products such as bathtubs, shower bases, shower surfaces, and floor panels, a great deal of flexibility is required in terms of color and surface texture in order to allow for freedom of design. For example, similarly to automotive paints, both very smooth, shiny enamel surfaces and matte enamel surfaces are known.

A distinction is also made in practice between matte frit and glossy frit, depending on the different appearance.

Surfaces and, in particular, floor coverings in the sanitary field usually pose a high risk of slippage under the influence of moisture. A thin film of water forms between the human skin and the surface whose formation is further promoted by surface-active substances such as those contained in personal care products such as shower gels, bath products, shampoos, or skin care products. In order to design a surface that is slip-resistant, the water film must be at least partially broken. Different measures can be taken for this purpose in order to produce roughness and micro-edges. In the field of enameled surfaces, it is known to apply to a smooth, glossy top enamel an additional layer of a special enamel that does not melt smoothly due to its composition during firing, but rather creates a defined roughness and thus has an antislip effect.

Such an antislip layer, which is often applied only locally or in a pattern, is fused inextricably with the underlying top enamel.

A bath or shower base formed in the described manner is known from DE 69 157 33. It is disadvantageous that, in this known embodiment, an additional enameling step must be carried out after application of the top enamel with a slurry that is suitable for generating the roughness, as well as an additional firing process.

This additional coating step can cover the entire surface of a shower base, for example, or be performed only in certain areas of shower bases and bathtubs and produce a limited area with increased slip resistance. Corresponding embodiments are described in the aforementioned DE 69 157 33.

An additional firing process can be avoided if the additional coating is done with a suitable slurry on a dried but not yet fired top enamel layer. Such dried layers are referred to as enamel biscuit or biscuit layers. After further drying, the top enamel layer is fired together with the additional antislip layer. The difficulty with such a method, however, is that the biscuit layer can be very easily damaged due to its low resistance to mechanical influences or to peeling or reflowing under the influence of moisture during the additional coating process. In order to avoid rejection of the end product, the metallic base body must be cleared of the damaged coating, cleaned, and returned to undergo the entire process again.

### OBJECTS OF THE INVENTION

It is therefore an object of the present invention to provide an improved method of making an enameled sanitary fixture.

Another object is the provision of such an improved method of making an enameled sanitary fixture that overcomes the above-given disadvantages, in particular with which good slip resistance can be achieved in a simple and acceptable manner.

Another object is to provide a blank for the formation of such an enameled sanitary product.

### SUMMARY OF THE INVENTION

A method for making an enameled sanitary product has according to the invention the step of applying a coating compound formed from at least one ground-enamel frit to a metallic base body. The compound containing a thermally unstable additive that decomposes when heated, and firing the base body coated with the compound such that the additive thermally decomposes and produces gas in the fired coating compound that forms bubbles and craters in the coating that are fixed on cooling of the base body.

The enameled sanitary product is usually intended to be stood and/or walked on by a user. It can therefore preferably be a bathtub, shower base, shower surface, or a floor panel. However, particularly if an optically uniform overall appearance is desired, other sanitary products such as wall panels or the like can also be constructed in a similar manner even if a special slip resistance is not necessary required.

The coating compound is usually embodied in the form of a slurry that is then sprayed as a suspension onto the metallic base body. A coating compound in the form of a dry powder that can be deposited by electrostatic forces on the metallic base body, for example, is less preferred but not categorically excluded.

In the context of the invention, the base body is usually a metal sheet. In an embodiment as a shower surface or floor panel, the metal sheet can be substantially flat. According to a preferred embodiment of the invention, however, a the metallic base body is formed as a steel sheet. In the case of a shower surface or a floor panel, for example, the edges can be bent and/or raised. On the other hand, in the case of an embodiment used as a bathtub or shower base, the steel sheet is usually deep-drawn.

The thickness of the steel sheet is typically between 1 mm and 3 mm.

In the method according to the invention, the thermally unstable additive is added during the formation of the coating compound, i.e. particularly a slurry in the form of an aqueous suspension, and decomposes at least partially to form gas during the firing process. The thermally unstable additive is usually added in the form of particles, so that the formation of gas occurs locally at the individual particles, more particularly through conversion of the individual particles. Accordingly, bubbles are formed during firing in the corresponding layer, which is initially still liquid.

Merely as a result of the production of gas bubbles, an uneven surface structure is produced that can already contribute to a certain extent to the desired reduction of risk of slipping. A thin film of water can be broken locally by an uneven and wavy structure or topography within the top enamel layer due to the gas bubbles.

In addition, individual gas bubbles in the initially still-liquid enamel layer can reach the surface during firing and burst there or exit the enamel layer. Increased roughness is achieved as a result of this as well, which contributes substantially to a reduction of the risk of slipping.

In particular, it is possible in the context of the method according to the invention to achieve a slip-resistant surface with only one top enamel coating that is formed with the inventive method. This results in a very robust, less sensitive coating with the coating compound that can then be fixed with only one firing process, with the desired slip resistance being achieved at the same time through the formation of the gas bubbles.

A magnesium carbonate compound is particularly provided as a thermally unstable additive. Magnesium carbonate and magnesium hydroxide carbonate, which can also be present in a mixture, in principle, are also suitable. These are magnesium carbonate salts that decompose at a temperature of about 350° C. In a conventional firing process, in which the maximum temperature can typically be between 750° C. and 900° C. and particularly about 850° C., the decomposition temperature is thus exceeded, so that carbon dioxide is released as a result of the decomposition of the magnesium carbonate compound.

The degree of surface waviness or surface roughness and thus also the degree of slip resistance can be varied of process control on the part of a person skilled in the art, it being possible for optimal parameters to be optionally determined by means of exploratory tests.

First of all, the use of magnesium carbonate compounds has the advantage that the decomposition takes place over a certain, comparatively long period of time, so that gas continues to form over a longer period of time during firing even if individual bubbles reach the surface and thus they exit the liquid enamel layer.

Moreover, the viscosity of the liquid enamel layer is also crucial. As the viscosity increases, the movement of the individual bubbles to the surface slows down. If the surface is already cooling at the same time, a kind of skin can already form there, which also counteracts excessive release of the gas formed.

In addition to the selection of a suitable thermally unstable additive, such as a magnesium carbonate compound, in particular, the proportion of the thermally unstable additive in the coating compound is of course also relevant. Based on 100 parts by weight of ground-enamel frit, the coating compound according to a preferred embodiment of the invention contains between 0.4 and 5 parts by weight of the thermally unstable additive.

If the thermally unstable additive is present in the form of particles according to a preferred embodiment of the invention, the size of the individual particles is of course also taken into account. Even if the desired antislip effect can always be achieved, the particle size must be determined in a suitable manner in the context of exploratory tests. With particles that are too small, the desired antislip effect is less pronounced, because the individual gas bubbles are ultimately very finely distributed in the corresponding enamel layer, so that the waviness or roughness of the surface due to the gas bubbles is also less pronounced. The result is a foam-like structure with a high gas content. The small bubbles also migrate only relatively slowly during the firing process and also reach the surface only slowly.

With particles that are too large, comparatively large gas bubbles can form. When such large gas bubbles burst on the surface, craters and color changes result that are visible to the eye, which can be perceived by a user as a defect. With large particles, the correspondingly large gas bubbles formed during the firing process have a high degree of mobility and can thus outgas too quickly. Apart from the fact that large, visible craters are also not desirable for optical reasons, many small craters are also better than fewer large craters in reducing the risk of slipping in consideration of an edge length of the craters formed.

In order to obtain particles of the thermally unstable additive appropriately in an optimum size, these particles can also be ground together with the enamel frit, in which case the slurry is subsequently formed from the resulting ground mixture. Grinding them together also ensures thorough mixing. According to a preferred development, during the grinding process, at first only the enamel frit is ground with the usual additives, and the thermally unstable additive is added subsequently.

As already explained above, the viscosity of the enamel layer, which is liquid during the firing process, and the hardening behavior can influence the mobility of gas bubbles. In light of this, according to a preferred embodiment of the invention the enamel frit provided for the coating compound is formed with at least one matte frit and one glossy frit or one glossy frit and ground quartz as a higher-melting, mattifying component. Moreover, it is also possible to form the coating compound from a glossy frit on the one hand and from the mixture of at least one matte frit and ground quartz on the other hand. During firing, constituents of the matte frit can crystallize out, which significantly increases the viscosity of the molten enamel layer and thus slows the outgassing of the gas. When a glossy frit and ground quartz are used, the viscosity of the molten enamel layer is increased through partial dissolution of the quartz in the glass matrix. Given this, it is especially preferred in the context of the invention if, based on 100 parts by weight of enamel frit, at least 20 parts by weight of matte frit or at least 10 parts by weight of quartz are provided. According to the invention, quartz as the glass-forming component of the enamel frit is counted in this context among the total of 100 parts by weight of enamel frit. Especially preferably, between 40 and 60 parts by weight of matte frit and between 60 and 40 parts by weight of glossy frit and between 60 and 90 parts by weight of glossy frit and 40 to 10 parts by weight of quartz are provided based on 100 parts by weight of enamel frit. If a combination of at least one glossy frit with at least one matte frit and quartz is provided, the proportions can be adjusted proportionally according to the criteria described above. It should be noted in this context that, in the invention, “enamel frit” also refers to a mixture of frits or frit and quartz and hence to the total amount.

The proportion by weight of the thermally unstable additive, which is preferably between 0.4 and 5, is also selected in the context of the invention as a function of the specific enamel frit that is provided. For example, if the enamel frit is composed exclusively of matte frit, the proportion by weight can be between 0.2 and 2, preferably between 0.5 and 1. The values given here also refer to 100 parts by weight of enamel frit. In a very bright enamel frit that contains white titanium glossy frit in addition to matte frit, the proportion by weight of the thermally unstable additive is for example between 1 and 5, particularly between 3 and 4.

As explained previously, magnesium carbonate, MgCO₃, or a magnesium hydroxide carbonate, such as 4 MgCO₃×Mg(OH)₂5×H₂O, is provided as a thermally unstable additive. Commercially available materials can also be ground together with the enamel frit (i.e., preferably a mixture of frits) in order to produce a desired particle size. With regard to the commercial products that are readily available, the initial particle size of the magnesium carbonate compounds described is typically in the range of a D10 between 7 μm and 28 μm, a D50 between 32 μm and 130 μm, and a D90 between 55 μm and 220 μm. The indicated values refer here to the particle size at 10%, 50%, and 90% throughput relative to the total mass according to the customary definitions. The initial particle size of the ground quartz is typically in a range of a D10 between 1 μm and 10 μm, a D50 between 20 μm and 50 μm, and a D90 between 80 μm and 120 μm.

The invention also relates to a blank for forming the enameled sanitary product before the firing process.

Finally, the invention also relates to the enameled sanitary product itself. According to the invention, the enameled sanitary product has gaseous inclusions in the form of carbon dioxide bubbles beneath the surface of a top enamel layer and crater-shaped formations on the surface, each with a depression and a raised wall. These specific characteristics result from the production of carbon dioxide, preferably from a magnesium carbonate compound as a thermally unstable additive, with the carbon dioxide bubbles initially formed during the firing process within the top enamel layer forming the crater-like formations upon emerging from the surface. In that case, both inclusions in the form of carbon-dioxide bubbles and crater-like formations are present in the finished enameled sanitary product. During the firing process, water vapor can be released from the residual moisture of the biscuit layer, the thermally unstable additive, and/or other components that can then accumulate inter alia in the carbon dioxide bubbles as well. As will readily be understood, the crater-like formations can have an uneven structure to a certain extent; in that case, however, the crater-like formations can be identified at least in large part in the approximately central depression and the raised wall that encircles the depression at least partially.

In the context of the invention, multilayer enameling is not excluded in principle. However, special advantages arise if, as explained above, only one top enamel layer is provided. In a configuration that is common for sanitary products, a slurry of a base enamel is applied to the metallic base body as a bonding, contact, and adhesive layer and fired after drying to form a base enamel layer, and the top enamel layer is then applied thereto in the manner described. However, embodiments are also possible in which only a top enamel is applied as a so-called direct enamel directly to the metallic base body, for which purpose the base body consists of nickel steel or is nickel-plated.

In the embodiment of the enameled sanitary product as a bathtub, shower base, shower surface, or floor panel, the surface forms a tread at least in areas, with the tread then usually having a slip resistance falling under evaluation group B or C according to DIN 51097:1992.

In following Table 1, various design variants are described by way of example.

TABLE 1

| | Slurry for very | | | | | | | |
|---|---|---|---|---|---|---|---|---|
| | bright colors (white | | | Slurry for bright | | | Slurry for | |
| | tones) | | | colors | | | dark colors | |
| Frit A | 50 | 20 | | 40 | 20 | | 60 | 40 |
| (transparent | parts | parts | | parts | parts | | parts | parts |
| matte frit) | | | | | | | | |
| Frit B | | | | | | | 40 | 60 |
| (transparent | | | | | | | parts | parts |
| frit) | | | | | | | | |
| Frit C | | | | 60 | | | | |
| (semi-opaque | | | | parts | | | | |
| glossy frit) | | | | | | | | |
| Frit D | | 50 | | | 40 | | | |
| (white matte | | parts | | | parts | | | |
| frit) | | | | | | | | |
| Frit E | 50 | 30 | 70 | | 40 | 80 | | |
| (white glossy | parts | parts | parts | | parts | parts | | |
| frit) | | | | | | | | |
| Quartz | | | 30 | | | 20 | | |
| | | | parts | | | parts | | |
| MgCO₃ or | 3 | 4 | 2 | 2 | 2.5 | 1.5 | 0.5 | 1 |
| magnesium | parts | parts | parts | parts | parts | parts | parts | part |
| hydroxide | | | | | | | | |
| carbonate | | | | | | | | |
| Slip resistance: | B | C | C | B | B | B | B | C |
| Evaluation | | | | | | | | |
| group | | | | | | | | |
| according | | | | | | | | |
| to DIN | | | | | | | | |
| 51097 | | | | | | | | |

### BRIEF DESCRIPTION OF THE DRAWING

The above and other objects, features, and advantages will become more readily apparent from the following description, reference being made to the accompanying drawing in which:

FIG. 1 is a section through an enameled sanitary product according to the invention;

FIG. 2 is a view like FIG. 1 of an alternative embodiment of the enameled sanitary product; and

FIG. 3 a top view of a sanitary product according to FIG. 1 or FIG. 2.

### SPECIFIC DESCRIPTION OF THE INVENTION

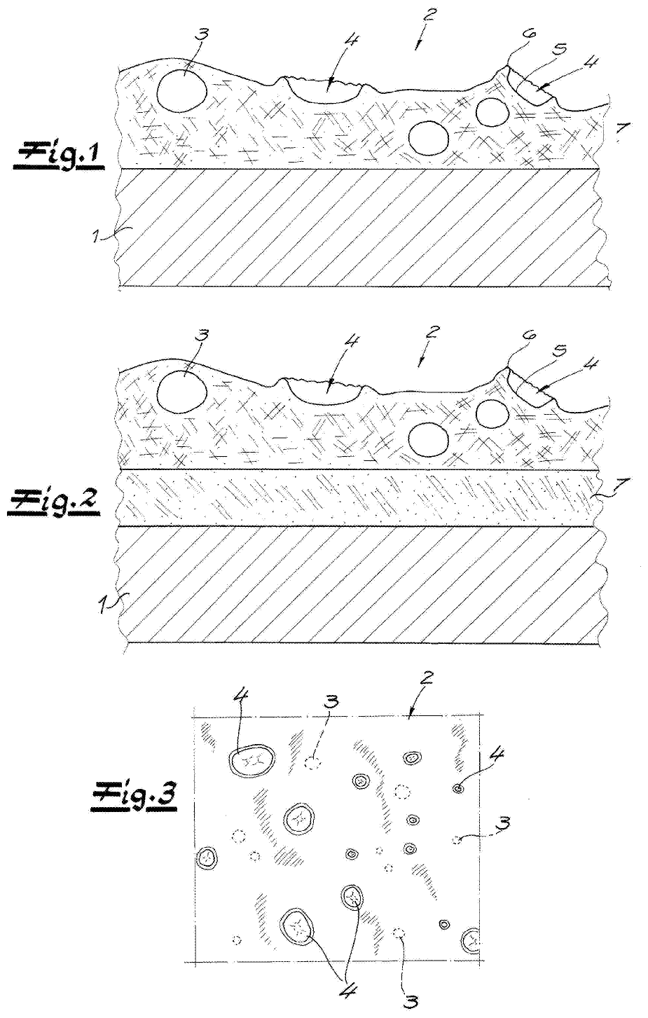

The enameled sanitary product can be preferably a bathtub, shower base, shower surface, or a floor panel, in which case a tread is formed for a user on the top side. According to FIG. 1 it has a metallic main body 1 usually made of a steel sheet. A single top enamel layer 2 is formed on the base body 1 as a direct enamel that is formed according to Table 1 from the mixture of various ground frits.

According to the invention, a thermally unstable additive, particularly a magnesium carbonate compound, is added during the preparation of the coating compound, which is usually applied as a slurry, with the thermally unstable additive decomposing at least partially during the firing process to form gas.

In this connection, FIG. 1 shows the structure of the top enamel layer 2 that is ultimately frozen in place in the finished enameled sanitary product. During the firing process, the decomposition of the magnesium carbonate compound forms gaseous carbon dioxide on the one hand and magnesium oxide on the other, and they are is incorporated into the glass structure of the top enamel layer 2. In addition, water vapor can also be generated.

Due to the viscosity of the top enamel layer 2 during the baking process, the gas generated is limited in its mobility. Inclusions 3 first occur in the form of carbon dioxide bubbles. When such a carbon dioxide bubble reaches the surface, it bursts or emerges from the enamel layer 2. A crater-shaped formation 4 is then produced with a depression 5 and a raised wall 6.

Since only a portion of the carbon dioxide bubbles can emerge from the top enamel layer 2, the enameled sanitary product according to FIG. 1 has both inclusions 3 and crater-shaped formations 4 that together increase the waviness or roughness of the surface formed by the top enamel layer 2 and thus contribute to improved slip resistance.

In order to enable only one top enamel layer 2 to be applied directly to the metallic base body 1 as a direct enamel, the base body 1 is usually nickel-plated and/or made of a nickel steel in order to make sufficient adhesion of the directly applied top enamel layer 2 possible.

Given this, a two-layered construction is frequently provided, especially for sanitary products, with FIG. 2 showing a base enamel layer 7 between the metallic base body 1 and the top enamel layer 2. The base enamel layer 7 and the top enamel layer 2 are baked in two successive firing processes. In the context of such an embodiment as well, the advantage exists over the prior art that the desired slip resistance can be achieved directly with the production of the top enamel layer 2.

In a highly magnified plan view, FIG. 3 shows a cut-out from the surface of an enameled sanitary product according to the invention with an edge length of 2.4 mm by 2 mm. The size of the individual crater-like formations 4, the size distribution, and the spatial arrangement can be estimated on the basis of the exemplary cut-out for a specific embodiment.

In the context of the invention, the inclusions 3 and thus also the crater-shaped formations 4 typically have a diameter of between 30 μm and 350 μm. A mean diameter is typically between 60 μm and 200 μm, for example about 120 μm

I claim:

1. A method for making an enameled sanitary product, the method comprising the step of:
applying a coating compound formed from at least one ground-enamel frit to a metallic base body, the compound containing a thermally unstable additive that decomposes and generates gas when heated;
firing the base body coated with the compound such that the additive thermally decomposes and generates gas inclusions that form bubbles in and craters in the fired coating compound; and
curing the fired base body and coating such that the bubbles and craters are fixed in the coating.

2. The method defined in claim 1, wherein the additive includes at least one magnesium carbonate compound.

3. The method defined in claim 1, wherein, based on 100 parts by weight of ground-enamel frit, the coating compound contains between 0.4 and 5 parts by weight of the thermally unstable additive.

4. The method defined in claim 1, further comprising the step of:
grinding the enamel frit and additive together prior to application of the coating compound to the base body.

5. The method defined in claim 4, wherein, during the grinding process, at first only the enamel frit is ground, and then the thermally unstable additive is added.

6. The method defined in claim 1, wherein, based on 100 parts by weight of enamel frit, at least 20 parts by weight of matte frit are provided.

7. The method defined in claim 6, wherein, based on 100 parts by weight of enamel frit, between 40 and 60 parts by weight of matte frit and between 60 and 40 parts by weight of glossy frit are used.

8. The method defined in claim 1, wherein, based on 100 parts by weight of enamel frit, at least 10 parts by weight of ground quartz are used.

9. The method defined in claim 8, wherein, based on 100 parts by weight of enamel frit, between 10 and 40 parts by weight of ground quartz and between 90 and 60 parts by weight glossy frit are used.

10. The method defined in claim 1, wherein the firing step is carried out at a maximum temperature between 750° C. and 900° C.

11. The method defined in claim 1, wherein the base body is a deep-drawn steel sheet.

12. A blank for forming an enameled sanitary product, the blank comprising the metallic base body and coating made according to the method of claim 1.

13. An enameled sanitary product comprising:
a metallic base body; and
a top enamel coating on the base body made of a ground-enamel frit mixed with a thermally unstable additive that generates gas when heated to form gas bubbles and craters in the coating.

14. The enameled sanitary product defined in claim 13, wherein the top enamel layer directly engages the metallic base body.

15. The enameled sanitary product defined in claim 13, for use as a tread or floor covering, the coating having a surface falling under evaluation group B or C according to DIN 51097:1992.
